(19) United States
(12) Patent Application Publication
(10) Pub. No.: US 2016/0260154 A1
(43) Pub. Date: Sep. 8, 2016

(54) METHOD FOR PROVIDING COMPARATIVE FITTING AND SIZING RECOMMENDATIONS FOR SADDLES

(71) Applicants: Robert DIADONE, Alexander, ME (US); Lisa Dereszewski, Alexander, ME (US)

(72) Inventors: Robert DIADONE, Alexander, ME (US); Lisa Dereszewski, Alexander, ME (US)

(21) Appl. No.: 15/053,960

(22) Filed: Feb. 25, 2016

Related U.S. Application Data
(60) Provisional application No. 62/129,504, filed on Mar. 6, 2015.

(51) Int. Cl. G06Q 30/06; G06T 7/00; G06F 17/30

(52) U.S. Cl. CPC G06Q 30/0631; G06F 17/30867; G06T 7/0075; G06T 2207/10028; G06T 2200/04; G06T 2207/10012

(57) ABSTRACT

A method for providing comparative fitting and sizing recommendations for saddles, saddle trees, and horse tack, using data from manufacturers which is formatted and stored in a database, a mobile device to capture data from an individual horse, formatting the horse's data for analysis, comparing the manufacturers' data with the horse's data via algorithms, fuzzy logic, and heuristics, and returning a recommendation of “best fit” match within user-determined selection criteria.

### BACKGROUND OF THE INVENTION

1. Technical Field

The present invention relates to the field of equestrian equipment, and more specifically, to a method for providing comparative fitting and sizing recommendations for saddles, saddle trees, and horse tack using a mobile device to capture data. The method includes obtaining, storing, analyzing and transferring data to a database for the purposes of comparing data for analysis, and returns a recommendation of “best fit” match within a selection array to the user. The method further discloses apparatus which includes the data capture devices, the data transfer devices, the data storage devices, the data processing devices, and the data display devices, one or more of which may be integrated into a single device, such as a smartphone.

2. Description of Prior Art

There are millions of domestic horses in the United States and millions of enthusiastic horse riders. For hundreds of years, riders have placed saddles onto the backs of horses for the protection of the horse and the comfort and safety of the rider. Each horse provides a unique anatomy, onto which riders attempt to fit an appropriate saddle. Ideally, the contours of the underside of a saddle are designed to approximate the contours of a horse's back and flanks, as near as possible. The fewer gaps and pressure points between a saddle and the horse, providing the best surface contact between the saddle and the horse, the better the fit. However, apart from custom made saddles, which are very expensive, most horses are fitted with mass manufactured saddles. Due to a lack of industry fitting standards, it is often very difficult to successfully choose the best fitting saddle for a particular horse.

Finding a “best fit” saddle or even a minimally correct fitting saddle to purchase or try out online or in person is extremely difficult and cost prohibitive for both the user and retailer because the user cannot readily try out and/or afford the cost to try out every saddle available to any particular horse. Moreover, even when an apparently “best fit” saddle is placed onto a horse, without fit analytics there is no accurate way to truly know that the fit is correct. Presently, the user has no industry standard for saddle fit to reference and therefore must attempt fit by one or more time consuming and/or cost prohibitive means, including, but not limited to, traveling to a saddle store, asking to try (with a deposit) a saddle (of a single style) to check for fit, or ordering online by the same selective process and likely having to return the saddle at a significant cost for shipping.

Up until now, the average consumer/rider would pick a size that they believe will fit their horse based on these general “bar” categories, discipline specifics, style and outward appearance, marketing, and a single measurement called the gullet measurement. The gullet measurement can typically range in size from 5″ to 9″ and represents the front of the saddle only. However, one number alone and horse type cannot address all the additional measurements and angles that go into the production of the saddle tree, i.e. rock, bar flare, spread, twist, etc., to make a determination on the quality of fit a saddle will be to the horse. A Quarter Horse Bar Tree for one company may be much wider or much narrower than another company's. This creates a significant problem in the equine manufacturing industry with respect to both terminology and basic understanding of saddle fit. In fact, most saddle fitters report that 90% of saddles they check do not fit the horse properly and pose a significant risk of harm to both horse and rider.

Correct saddle fit is more than just problematic as a financial and economic deterrent. Ill fitting saddles represent a primary safety issue for the user. Poorly fitted saddles subject the horse to acute and chronic pain, leading to loss of concentration and discomfort for the animal, a major contributor to personal injury in riders costing billions of dollars in losses, both economically and through medical claims and lost work time. The problem of poor fit leads to a host of additional expenses to the horse owner including, horse chiropractor care, expensive veterinary and supplementation expense, the necessity to purchase additional saddles, horse training, and in extreme cases the purchase of a new horse.

Examples of sizing/fitting difficulty for users abound. A horse's back is a dynamic object that is constantly in motion. It is also dynamic in that it changes shape with development from activity, and seasonally over time. While the back of a single horse may stay relatively stable over time, some deviation will occur necessitating a “best fit” choice for the user based on, but not exclusive to, style, discipline, and breed to ensure adequate comfort and safety over the life of the animal and/or saddle.

Because horse backs are as individual morphologically as their riders, while the saddle can easily be fit for the rider, no one saddle will fit all horses. The saddle fit industry is a large one and is comprised of professional saddle fitters who attempt to correct ill-fitting saddles by narrowing down saddle choices for the consumer, saddle tree makers who claim that their trees fit a greater majority of horses, specialty saddle pad makers who claim their pads will assist in a better fit of most saddles, and saddle manufacturers who claim their saddles have better elements for a better fit. In reality, the only way a saddle will fit optimally to a horse's back is if the tree is made specifically for that particular horse being fitted for a saddle.

Because manufacturer sizing varies extensively and there is no current standard for saddle manufacturing and/or sizing available, the user currently must select a saddle by style and available manufacturer-specific size options the user thinks will fit their horse without the advantage of accepted sizing guides in use within the saddle industry. However, because of the previously mentioned lack of industry standard for fitting, coupled with the extreme difficulty in determining fit and fitting, the user is put in the unfortunate position of guessing fit at great expense. The likelihood of a ill-fitting saddle is high and the user is obliged to be out of pocket for the shipping costs for an ill-fitting saddle, as well as the seller is out of sellable inventory as the process takes time. The seller also risks the depreciation of their goods due to negligence or accident. All of which are a deterrent for the seller, and in fact prohibit many sellers from allowing users to try inventory in advance of purchase, further decreasing sales and marketing possibilities.

The majority of users in the United States are vulnerable in a number of ways due to the difficulty in sizing a horse to an optimally fitted saddle. One of these is due to the expense that a new saddle costs the user. Another is that the user may have multiple horses to ride and intends to use the same saddle for more than one horse at a time. Ill fitting saddles are a deterrent to purchasing because there is a user assumption that ill fitting saddles are the norm (because they are common) and the consumer is avoiding a significant expense without significant value for their large ticket purchase.

What is needed, then, is a method for capturing and storing the geometry of saddles (including mass manufactured saddles, small production run saddles, out of production saddles, and custom made saddles), a method for capturing the specific anatomy of a particular horse, and a method for comparing the anatomy of that horse against the stored saddle data using algorithms and heuristics which establish a “best fit”. Apparatus are required to make the data capture easy and the results available in locations where horses may be found.

It is thus an object of the present invention to present a method and apparatus for determining the best fitting options of saddles for a particular horse by employing a “best fit” match analysis and presenting the results directly to the user (including riders, manufacturers, and saddle designers).

It is a further object of the present invention to present a method and apparatus for capturing data from mass manufactured saddles and/or saddle trees.

It is yet a further object of the present invention to present a method and apparatus for storing data captured from mass manufactured saddles and/or saddle trees in a form conducive to comparison analysis.

It is yet a further object of the present invention to present a method and apparatus for capturing data from the anatomy of a particular horse.

It is yet a further object of the present invention to present a method and apparatus for providing data captured from a particular horse in a form conducive to comparison analysis.

It is yet a further object of the present invention to present a method and apparatus for comparing data from stored mass manufactured saddles and/or saddle trees against data provided from a particular horse using algorithms to determine “best fit”.

It is yet a further object of the present invention to present a method and apparatus for recommending one or more saddles and/or saddle trees as a “best fit” for a particular horse.

It is yet a further object of the present invention to present a method and apparatus for providing data and recommendations concerning one or more saddles and/or saddle trees to manufacturers and saddle designers.

Other features and attendant advantages of the present invention will become obvious to the reader and become fully appreciated as the same becomes better understood when considered in conjunction with the accompanying drawings. It is intended that these objects and advantages are within the scope of the present invention. To the accomplishment of the above and related objects, this invention may be embodied in the form illustrated in the accompanying drawings. Attention being called to the fact, however, that the drawings are illustrative only, and that changes may be made in the specific construction illustrated and described within the scope of this application.

### SUMMARY OF THE INVENTION

The present invention concerns selecting the best saddle and/or saddle tree for a particular horse. A saddle tree is an internal form around which a saddle is built and the part of the saddle that must make contact with the horse's back in order for the saddle to perform properly and ensure safety. Saddles with different external features and aesthetics may be made using the same saddle tree. There are fewer styles of saddle trees than there are saddles. Therefore, the capture and storage of saddle tree data is a useful proxy for capturing and storing data from every specific saddle that is manufactured. However, with regard to certain very popular saddles, the direct capture and storage of data is practical and useful.

The present invention uses image scanning and capture technology to capture raw data, converts that data into a three dimensional (3D) point cloud structure, then uses algorithms, fuzzy logic, and heuristics to compare data structures for “best fit”. As contemplated herein, “best fit” means a saddle or a saddle tree having the shape and dimensions that most closely approximate the anatomy of the particular horse for which they are intended, so that when a “best fit” saddle is placed on a particular horse the performance and safety of that saddle is maximized and discomfort to the horse is minimized. In addition to sizing, “best fit” also takes into account additional factors, such as appropriateness for the intended use, rider characteristics such as height and weight, cost, quality, origin of manufacture, and other factors important to the user.

The present invention comprises a method and apparatus for providing comparative fitting and sizing recommendations for, but not limited to, saddles, saddle trees, and horse tack using a mobile device, including but not limited to a smart phone, a computer, a tablet (such as an iPad®), or wearable technology operated locally or remotely. The method includes, but is not limited to, obtaining, storing, analyzing and transferring data to a database for the purposes of, but not limited to, comparing algorithm led data fields for deviation analysis, self-similarity analysis, field dynamics and/or field interaction based interpretation of 3D image data, and returns a recommendation of “best fit” match within a selection array to the user. Comparative algorithm led data fields include, but are not limited to, 3D scanned data fields of: static-static, static-dynamic (for example a horse's back and fit form and/or saddle) and/or dynamic-dynamic objects.

Other features and advantages of the invention are described below.

### DESCRIPTION OF THE DRAWING

FIG. 1 depicts a schematic of the data capture and analysis process.

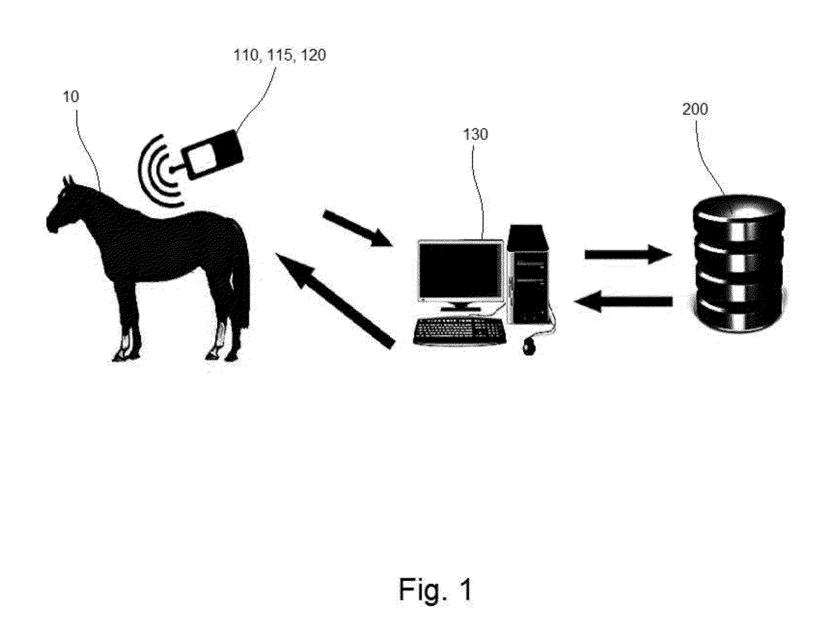

FIG. 2 depicts a representation of the 3D point cloud structure for the captured data.

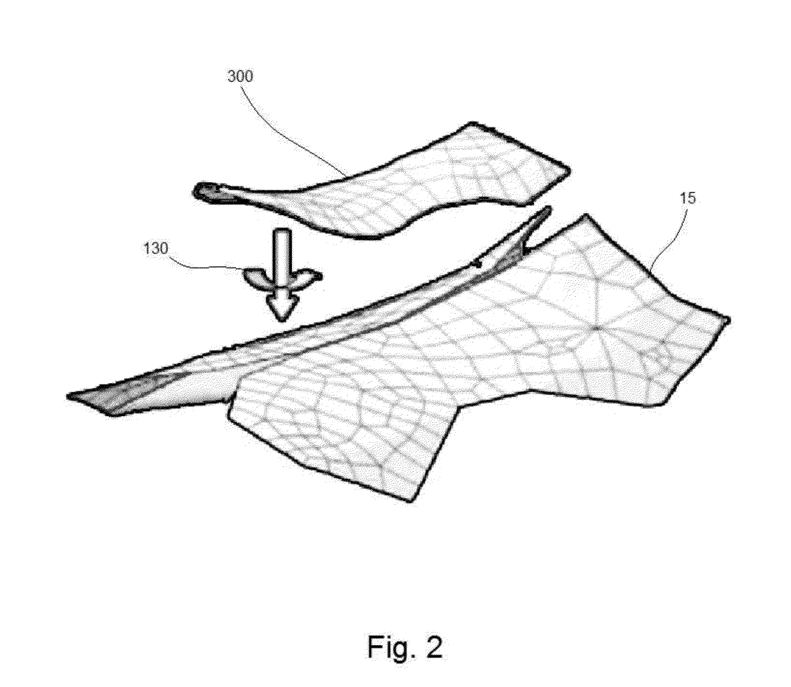

FIG. 3 depicts a flow chart of one embodiment of the method of the present invention.

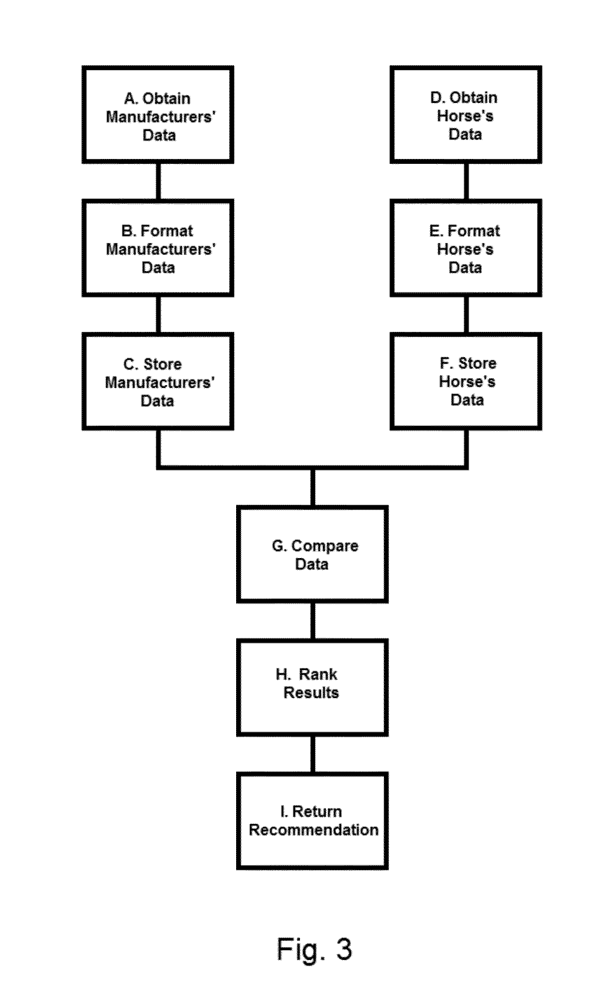

FIG. 4 depicts a flow chart of another embodiment of the method of the present invention.

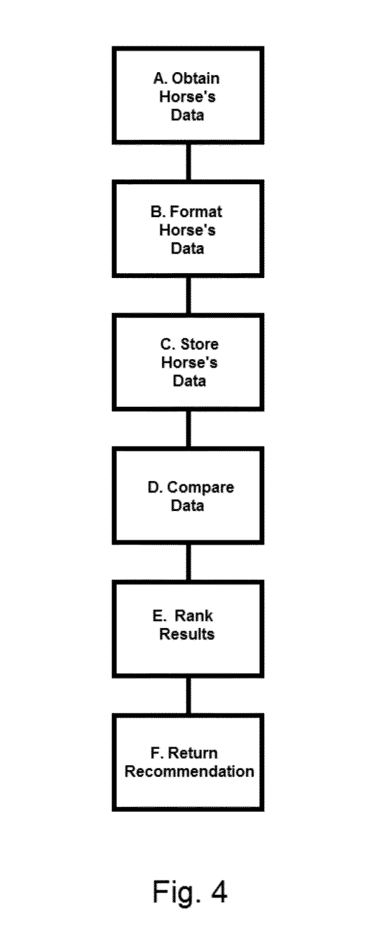

### DETAILED DESCRIPTION OF THE INVENTION

The present disclosure relates to providing a user with tack and/or saddle information based upon the user's 3D scan of one or more horses' 10 backs 15. More specifically, the present disclosure relates to providing a user information related to a saddle model based upon the user's selection of a “best fit” (or “optimal fit”) from an array related to horse back/saddle deviation analysis and/or related database 200 provided information (i.e. what saddles are being used and/or manufactured for specific disciplines).

The present invention uses a remote peripheral device 110 and a mobile application 120 for data capture relevant to a particular horse's 10 anatomy, then processes that data and compares it against known quantities stored in a database 200, with the comparison resulting in the return of a “best fit” match of saddles/saddle trees to the horse 10. The saddles/saddle trees may be from current manufacturers, or may be out of production, or custom made. Additionally, saddle trees may be created using 3D printing from the data capture process.

The present invention contemplates various means for data capture. One means is through the use of stereophotogrammetry. Stereophotogrammetry uses multiple photographic images taken from different positions in order to determine the 3D coordinates of specific points on a target surface, in this case, a horse's back 15. This approach typically requires the placement of special markers and/or texture on the surface, and then the capture of images including the markers and/or texture. Accurate image capture using stereophotogrammetry is dependent on camera digital resolution, f-number, and focal length, and the overall accuracy of the image capture technology. Currently available smartphones have built-in cameras that are of sufficient quality as to be able to capture usable images. The use of smartphones allows for easy transfer of those images to a computer for processing. In addition, other factors are taken into account when processing images, including ambient light conditions, image blur, the number of photos required, the distance of the camera to the target surface, the angle of camera to the target surface, even the brand of smartphone.

Another means of data capture uses IR scanning technology 115. This technology currently provides more accurate data capture than smartphone-based camera stereophotogrammetry, but requires more expensive, dedicated equipment. The use of IR scanning technology 115 for data capture of the target surface may be more appealing in the future if this technology becomes integrated with mobile technologies. IR scanning technology 115 is currently being used and is contemplated to be included in the scope of the apparatus.

The captured data is converted into 3D coordinates 300 defining the horse's back 15 and flanks. Manufacturer specific saddle trees are also stored in a database 200 as 3D coordinates. The 3D coordinate data 300 may be stored as any of the following: a point cloud of x,y,z data, a mesh defining the surface, or a listing of fitted splines. Other appropriate representations are also contemplated. The method uses one or more algorithms embodied in computer software 130 to compare the captured data against the stored data to determine the best fit to the subject horse 10 of a particular saddle tree. Multiple saddle trees may be returned and sorted by user selected criteria, such as cost, style, manufacturer, etc.

The database 200 of stored saddle tree data is constructed either from manufacturer provided geometry or from direct scans of saddle trees using the same apparatus as is used for capturing data from a particular horse 10, or both. In addition to the storage of 3D coordinate data 300 for saddle tress, saddle tree measurements are evaluated and stored in the database 200 for each tree. Saddle tree measurements include the following, at a minimum: gullet width, bar angle, rocker angle, twist angle, and bar length. Other criteria may also be stored.

The comparison algorithm uses non-linear optimization techniques to align the horse back 15 to the saddle tree by minimizing the residual between surface data, for example, using bi-conjugate gradient method or genetic algorithm. Heuristics specific to saddle fitting are implemented to constrain the optimization. The deviations between the two sets of 3D surface data are evaluated using fuzzy membership functions (fuzzy logic) to determine the fitness ranking. Only saddle trees scoring above a predetermined minimum threshold will be identified to the user as acceptable.

The genetic algorithm (GA) is a search heuristic that mimics the process of natural selection (also sometimes called a metaheuristic) and is routinely used to generate useful solutions to optimization and search problems. Genetic algorithms belong to the larger class of evolutionary algorithms (EA), which generate solutions to optimization problems using techniques inspired by natural evolution, such as inheritance, mutation, selection, and crossover. The algorithms of the present invention for determining best fit are a method for alignment of the saddle tree (reference) to the measured horseback profile (data), with the weighted mean squared error between the two datasets being minimized using an optimization technique. Weights will be determined using saddle fitting expertise, with regions of higher importance being weighted higher. Weights will become part of the knowledge base.

The means for optimization may be implemented using the iterative closest point method (ICP), a genetic algorithm (GA), or a hybrid ICP-GA approach. Optimization may be constrained with both spatial limits and heuristics determined from saddle fitting expertise, to avoid finding a non-optimal alignment solution in local minima. Upon completion of the optimization and alignment of the data to reference, a point-to-point, point-to-plane, or plane-to-plane deviation evaluation will be made. Deviation may be signed or unsigned distance or angular measurement. The same weights may again be used to compute the weighted or unweighted absolute deviation, as a sum, mean, median, root mean square, or any normalization of deviation or relative deviation evaluated similarly when comparing a series of references to the data. The evaluation of deviation will be used to rank the fitness of each reference to the data. All such evaluations and rankings will be stored in the database 200.

The present invention also contemplates a method of displaying saddle information, comprising: maintaining a database 200 on a computer readable medium, having the database 200 include a plurality of saddle representations wherein each saddle representation comprises data related to specific sizing information for an associated manufacturer, brand, style, etc. against the sizing of the end-user's horse 10.

The method of the present invention contemplates the following steps:
1. Acquiring data files: Digital point clouds representing 3D objects are acquired via imaging peripherals (including wired and wireless imaging peripherals) operated locally or remotely. Imaging may include, but is not limited to, targeted or non-targeted stereophotogrammetry, dense surface modeling (DSM), single image photography, or 3D scanning including but not limited to IR, PET, CAT, MRI, sonar or other electromagnetic scan technology. Images may be obtained via the use of wireless peripherals which include, but not limited to, smart peripherals, i.e., smartphones, wrist bands, glasses, hand-held computers, tablets, drones, or hand held or wearable peripherals.
2. File transfer: Images are processed remotely or transferred raw or in file format electronically to a database 200. Images formats include all file formats associated with current and future scan and stereophotogrammetry devices.
3. Data processing: The database 200 receives image files and assigned numerical and consumer information, i.e., information collected for the purpose of sizing, comparisons, data extraction, database reference, and other purposes deems significant for use with the method of the present invention. Data is processed using multiple extraction and comparative metrics and analytics for the sole purpose of developing the database 200 and determining “best fit” metrics.
4. User input: A user downloads a mobile application 120 to their smart peripheral 110. The user inputs information requested by the mobile application 120 to identify the project, including information about the horse 10 to be fitted. The user acquires one or more photos, 3D scans, or equivalent point cloud file using the data acquisition peripheral. The user confirms proper data acquisition then uploads files digitally to the application database 200. The acquisition and uploading of data by the user is done in a manner similar to the initial data acquisition and uploading described in steps 1-3, above.
5. Comparison: A best-fit algorithm optimizes the fit of the client point cloud to the saddles in the database 200. A best-fit will be determined by evaluating fit metrics derived from expert saddle-fitting knowledge. The algorithm returns one or more matched fit arrays to the peripheral device 110. The user then uses this information when accessing search functionality, with filters for style, price, discipline, country of origin, maker, brand, tree maker, materials, or performance, based on any of the fit metrics returned by the algorithm. Once a saddle is selected, the user can place an order from the manufacturer.

What has been described and illustrated herein is a preferred embodiment of the invention along with some it its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect. Other embodiments not specifically set forth herein are also within the scope of the following claims, whereby modifications and variations can be made to the disclosed embodiments of the present invention without departing from the subject of the invention as defined in the following claims.

I claim:

1. A method for providing comparative fitting and sizing recommendations for saddles, saddle trees, and horse tack, said method comprising the following steps:
A. obtain data from a plurality of manufacturers, whereby for each said manufacturer said data comprises specifications for one or more products, said products being of the group of saddles, saddle trees, and horse tack manufactured by said manufacturer;
B. format said data obtained from said plurality of manufacturers;
C. store said data obtained from said plurality of manufacturers in a database;
D. obtain biometric data from an individual horse using a device to capture said biometric data from said horse.
E. format said biometric data obtained from said horse;
F. store said biometric data obtained from said horse in the database;
G. for at least two of the plurality of manufacturers, perform a comparison of at least some of each said manufacturers' data with said horse's biometric data for the purpose of determining “fit” between said manufacturer's data and said horse's biometric data;
H. rank results of the comparison; and
I. return a recommendation of one or more “best fit” matches;
whereby
steps A and D occur in any order relative to each other,
steps B, C, E, and F occur in any order relative to each other, except that step B occurs after step A, step C occurs after step B, step E occurs after step D, and step F occurs after step E,
step G occurs after steps C and F,
step H occurs after step G, and
step I occurs after step H.

2. The method of claim 1 wherein the comparison performed in step G is comprised of the following substeps:
G1. for each of one or more of the products offered by each of the plurality of manufacturers, assess the deviation between the manufacturer's data associated with said product and the biometric data from the horse to obtain a raw rank score for said product;
G2. compare the raw rank score of the data from each of said products against a pre-determined threshold score;
G3. eliminate from further comparison all products having a raw ranked score failing to meet the threshold score;
G4. for all products not eliminated in substep G3, compare each product against each other non-eliminated product, applying pre-determined weighting criteria to the products' respective raw ranked scores.

3. The method of claim 1 further comprising the following step:
F1. provide user-determined selection criteria;
wherein step H accomplishes the ranking of the results of the comparison performed in step G by comparing said results against the user-determined selection criteria;
whereby
steps A, D, and F1 occur in any order relative to each other, and
step H occurs after step F1.

4. The method of claim 3 wherein the user-determined selection criteria comprises one or more of the group of price, materials, weight, discipline, style, manufacturer, brand, country or origin, performance, and percentage of matching fit data points.

5. The method of claim 1 wherein in step B the data obtained from the manufacturers is formatted into three dimensional coordinates.

6. The method of claim 1 wherein in step B the data obtained from the manufacturers is formatted into a three dimensional point cloud structure.

7. The method of claim 1 wherein in step B the data obtained from the manufacturers is formatted into a three dimensional mesh structure.

8. The method of claim 1 wherein in step B the data obtained from the manufacturers is formatted into a three dimensional listing of fitted splines.

9. The method of claim 1 wherein in step B the data obtained from the manufacturers is formatted into three dimensional surface geometry.

10. The method of claim 1 wherein in step F the biometric data obtained from the horse is formatted into three dimensional coordinates.

11. The method of claim 1 wherein in step F the biometric data obtained from the horse is formatted into a three dimensional point cloud structure.

12. The method of claim 1 wherein in step F the biometric data obtained from the horse is formatted into a three dimensional mesh structure.

13. The method of claim 1 wherein in step F the biometric data obtained from the horse is formatted into a three dimensional listing of fitted splines.

14. The method of claim 1 wherein in step B the biometric data obtained from the horse is formatted into three dimensional surface geometry.

15. The method of claim 1 wherein obtaining biometric data from said horse in step D is through the use of stereophotogrammetry.

16. The method of claim 15 further comprising the following step:
D1. place a plurality of markers onto at least a portion of the back and flanks of the horse;
whereby
step D1 occurs before step D.

17. The method of claim 1 wherein obtaining biometric data from said horse in step D is through the use of three dimensional scanning, using one or more of the following group: IR scanning technology, PET scanning technology, CAT scanning technology, MRI scanning technology, and sonar.

18. The method of claim 1 wherein the biometric data obtained from the horse comprises a subset of anatomical features of at least a portion of the back and flanks of the horse.

19. The method of claim 1 wherein the biometric data obtained from the horse comprises a three dimensional map of the topography of at least a portion of the back and flanks of the horse.

20. The method of claim 1 wherein the device used to obtain biometric data from the horse is one of the group of a smartphone, a tablet computing device, a laptop computer, a notebook computer, smart glasses, a wearable computer, a drone, a handheld scanner, and an IR scanner.

21. The method of claim 1 wherein the device used to obtain biometric data from the horse comprises a plurality of wearable sensors.

22. The method of claim 1 wherein the data from the plurality of manufacturers obtained in step A is provided by said manufacturers.

23. The method of claim 1 wherein the data from the plurality of manufacturers obtained in step A is obtained by scanning product offered by said manufacturers.

24. The method of claim 23 wherein obtaining data from said plurality of manufacturers in step A is through the use of stereophotogrammetry.

25. The method of claim 23 wherein obtaining data from said plurality of manufacturers in step A is through the use of IR scanning technology.

26. The method of claim 23 wherein obtaining data from said plurality of manufacturers in step A is through the use of dense surface modeling (DSM).

27. The method of claim 1 wherein the specifications described in step A comprise saddle geometry.

28. The method of claim 1 wherein the specifications described in step A comprise one or more of the group of gullet measurement, rock, bar flare, bar length, rocker angle, spread, and twist angle.

29. The method of claim 1 wherein the comparison performed in step G comprises one or more of the following: deviation analysis of the data, self-similarity analysis of the data, field dynamics and field interaction based interpretation of three dimensional image data.

30. The method of claim 1 wherein the comparison performed in step G comprises optimization techniques to align the horse's back to the manufacturers' saddle tree by minimizing or obtaining a target deviation between surface data by using any conjugate gradient method.

31. The method of claim 30 wherein the genetic algorithm uses a weighted deviation comparison between the manufacturers' saddle tree data and the horse's biometric data.

32. The method of claim 1 wherein the comparison performed in step G comprises optimization techniques to align the horse's back to the manufacturers' saddle tree by minimizing or obtaining a target deviation between surface data by using an iterative closest point algorithm.

33. The method of claim 32 wherein the genetic algorithm uses a weighted deviation comparison between the manufacturers' saddle tree data and the horse's biometric data.

34. The method of claim 1 wherein the comparison performed in step G comprises optimization techniques to align the horse's back to the manufacturers' saddle tree by minimizing or obtaining a target deviation between surface data by using a genetic algorithm.

35. The method of claim 34 wherein the genetic algorithm uses a weighted deviation comparison between the manufacturers' saddle tree data and the horse's biometric data.

36. A method for providing comparative fitting and sizing recommendations for saddles, saddle trees, and horse tack, said method comprising the following steps:
A. obtain biometric data from an individual horse using a device to capture said biometric data from said horse.
B. format said biometric data obtained from said horse;
C. store said biometric data obtained from said horse in a database;
D. for at least two of the plurality of manufacturers, compare said horse's biometric data against at least some of each said manufacturers' data, whereby for each said manufacturer said manufacturer's data comprises specifications for one or more products belonging to one or more of the group of saddles, saddle trees, and horse tack manufactured by said manufacturer, said comparison being for the purpose of determining “fit” between each said manufacturer's data and said horse's biometric data;
E. rank results of the comparison; and
F. return a recommendation of one or more “best fit” matches;
whereby
steps A through F occur in the order presented.

37. The method of claim 36 wherein the comparison performed in step D is comprised of the following substeps:
D1. for each of one or more of the products offered by each of the plurality of manufacturers, assess the deviation between the manufacturer's data associated with said product and the biometric data from the horse to obtain a raw rank score for said product;
D2. compare the raw rank score of the data from each of said products against a pre-determined threshold score;
D3. eliminate from further comparison all products having a raw ranked score failing to meet the threshold score;
D4. for all products not eliminated in substep D3, compare each product against each other non-eliminated product, applying pre-determined weighting criteria to the products' respective raw ranked scores.

38. The method of claim 36 further comprising the following step:
C1. provide user-determined selection criteria;
wherein step E accomplishes the ranking of the results of the comparison performed in step D by comparing said results against the user-determined selection criteria;
whereby
steps C1 occurs in any order relative to steps A through C, and step E occurs after step C1.

39. The method of claim 38 wherein the user-determined selection criteria comprises one or more of the group of price, materials, weight, discipline, style, manufacturer, brand, country or origin, performance, and percentage of matching fit data points.
